(19) United States
(12) Patent Application Publication
(10) Pub. No.: US 2017/0308645 A1
(43) Pub. Date: Oct. 26, 2017

(54) METHOD AND SYSTEM FOR REPRESENTING COMPOSITIONAL PROPERTIES OF A BIOLOGICAL SEQUENCE FRAGMENT AND APPLICATIONS THEREOF

(71) Applicant: Tata Consultancy Services Limited, Mumbai (IN)

(72) Inventors: Sharmila Shekhar MANDE, Pune (IN); Mohammed Monzoorul HAQUE, Pune (IN); Tungadri BOSE, Pune (IN); Anirban DUTTA, Pune (IN); Venkata Siva Kumar Reddy CHENNAREDDY, Pune (IN)

(73) Assignee: Tata Consultancy Services Limited, Mumbai (IN)

(21) Appl. No.: 15/268,245

(22) Filed: Sep. 16, 2016

(30) Foreign Application Priority Data
Apr. 25, 2016 (IN) 201621014353

(51) Int. Cl. G06F 19/24; G06F 19/22

(52) U.S. Cl. CPC G06F 19/24; G06F 19/22

(57) ABSTRACT

A method and system is provided for representing compositional properties of a biological sequence fragment and application thereof. The present application provides a method and system for representing compositional properties of a biological sequence fragment using a unidimensional compositional metric; comprising of collecting a plurality of biological sequence fragments; sequencing collected plurality of biological sequence fragments; generating a first set of reference vectors; computing a unidimensional compositional metric for each sequenced biological sequence fragment out of the plurality of sequenced biological sequence fragments as a cumulative function of the distance of the tetra-nucleotide frequency vector (v) from three or more reference vectors selected out of the generated first set of reference vectors; and segregating each sequenced biological sequence fragment out of the plurality of sequenced biological sequence fragments in to a plurality of groups based on respective unidimensional compositional metric.

### CROSS-REFERENCE TO RELATED APPLICATIONS AND PRIORITY

The present application claims priority from Indian non-provisional specification no. 201621014353 filed on 25 Apr. 2016, the complete disclosure of which, in its entirety is herein incorporated by references.

### TECHNICAL FIELD

The present application generally relates to computing a numerical score for any given biological sequence. Particularly, the application relates to representing compositional properties of biological sequences using computed numerical score. More particularly, the application provides a method and system for representing compositional properties of a biological sequence fragment using a unidimensional compositional metric, wherein the computed metric finds utility in various genomic and metagenomic applications which involve comparison, categorization and/or annotation of multiple biological sequences.

### BACKGROUND

Current generation of sequencing platforms can generate millions of biological sequences in a single overnight run. Consequently, categorization and/or biological annotation of these sequences requires comparison of the generated biological sequences either amongst themselves or with sequences listed in existing sequence databases.

A majority of existing biological sequence comparison solutions rely on employing sequence alignment or sequence composition-based procedures. However, the alignment-based comparison of multiple biological sequences represents a NP-hard problem. Some of the prior art literature also describe about sequence composition-based procedures for comparison of biological sequences based on one or more compositional properties, which is/are represented typically in form of multidimensional vectors. However, analyzing large volumes of biological sequences using either of these procedures is typically compute intensive making real-time data analysis a significant challenge.

It is expected that comparison between biological sequences represented using a compositional metric that has ‘fewer’ dimensions would be relatively less compute intensive as compared to using a compositional metric that has a ‘higher’ number of dimensions. Most of the existing dimensionality reduction techniques such as PCA, MDS perform dimensionality reduction by decomposing the original dimensions in a dataset and creating a smaller number of entirely new dimensions to describe the data. Therefore, while comparing multiple datasets by employing existing dimensional reduction techniques, it becomes necessary to merge all the compared datasets prior to proceeding with the ‘dimensionality reduction’ and subsequent analysis. This renders the overall comparison procedure even more compute intensive with increasing number of datasets.

Prior art literature have illustrated various methods and techniques for biological sequence comparison, however, designing a method and system for representing compositional properties of a biological sequence fragment using a compositional metric with minimum number of dimensions, such as one, i.e. unidimensional, to be used for various genomic and metagenomic applications involving comparison of multiple biological sequences, is a significant technical challenge.

### SUMMARY

Before the present methods, systems, and hardware enablement are described, it is to be understood that this invention is not limited to the particular systems, and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention which will be limited only by the appended claims.

The present application provides a method and system for representing compositional properties of a biological sequence fragment using a unidimensional compositional metric.

The present application provides a computer implemented method for representing compositional properties of a biological sequence fragment using a unidimensional compositional metric, wherein said method comprises collecting a plurality of biological sequence fragments; sequencing collected plurality of biological sequence fragments; generating a 256-dimensional tetra-nucleotide frequency vector (v) corresponding to the each sequenced biological sequence fragment out of the plurality of sequenced biological sequence fragments wherein the 256-dimensional tetra-nucleotide frequency vectors are subjected to Principal Component Analysis (PCA); selecting two vectors that lie at the extremes of the first principal component, i.e. the two selected vectors are maximally separated along PC1 (i.e. principal component 1); repeating selection of two discrete vectors each for PC2, PC3, . . . , PCn, so as to select two discrete vectors in each iteration, proceeding in the order of PC1, PC2, PC3 . . . . PCn, for generating a first set of reference vectors, wherein the first set of reference vectors comprises of the discrete vector pairs arranged in the order of their selection, i.e. in an order in which the reference vector pairs derived from the extremes of the most significant principal components precede reference vector pairs derived from the extremes of relatively less significant principal components; computing a unidimensional compositional metric for each sequenced biological sequence fragment out of the plurality of sequenced biological sequence fragments as a cumulative function of the distance of the tetra-nucleotide frequency vector (v) corresponding to an individual biological sequence fragment, from the first three or more reference vectors selected out of the generated first set of reference vectors; and segregating each sequenced biological sequence fragment out of the plurality of sequenced biological sequence fragments in to a plurality of groups based on respective unidimensional compositional metric.

The present application provides a system (200) for representing compositional properties of a biological sequence fragment using a unidimensional compositional metric; said system (200) comprising; said system (200) comprising a processor; a data bus coupled to said processor; a computer-usable medium embodying computer code, said computer-usable medium being coupled to said data bus, said computer program code comprising instructions executable by said processor and configured for executing a biological sequence fragment collection module (202) adapted for collecting a plurality of biological sequence fragments; a biological sequence fragment sequencing module (204) adapted for sequencing collected plurality of biological sequence fragments; a reference vectors generation module (206) adapted for generating a 256-dimensional tetra-nucleotide frequency vector (v) corresponding to the each sequenced biological sequence fragment out of the plurality of sequenced biological sequence fragments wherein the 256-dimensional tetra-nucleotide frequency vectors are subjected to Principal Component Analysis (PCA); selecting two vectors that lie at the extremes of the first principal component, i.e. the two selected vectors are maximally separated along PC1 (principal component 1); repeating selection of two discrete vectors each for PC2, PC3, . . . , PCn so as to select two discrete vectors in each iteration, proceeding in the order of PC1, PC2, PC3 . . . . PCn, for generating a first set of reference vectors, wherein the first set of reference comprises of the discrete vector pairs arranged in the order of their selection, i.e. in an order in which the reference vector pairs derived from the extremes of the most significant principal components precede reference vector pairs derived from the extremes of relatively less significant principal components; a unidimensional compositional metric computation module (208) adapted for computing a unidimensional compositional metric for each sequenced biological sequence fragment out of the plurality of sequenced biological sequence fragments as a cumulative function of the distance of the tetra-nucleotide frequency vector (v) corresponding to an individual biological sequence fragment, from the first three or more reference vectors selected out of the generated first set of reference vectors; and a sequenced biological sequence fragment segregation module (210) adapted for segregating each sequenced biological sequence fragment out of the plurality of sequenced biological sequence fragments into a plurality of groups based on respective unidimensional compositional metric.

In another embodiment, a non-transitory computer-readable medium having embodied thereon a computer program for representing compositional properties of a biological sequence fragment using a unidimensional compositional metric, wherein said method comprises collecting a plurality of biological sequence fragments; sequencing collected plurality of biological sequence fragments; generating a 256-dimensional tetra-nucleotide frequency vector (v) corresponding to the each sequenced biological sequence fragment out of the plurality of sequenced biological sequence fragments wherein the 256-dimensional tetra-nucleotide frequency vectors are subjected to Principal Component Analysis (PCA); selecting two vectors that lie at the extremes of the first principal component, i.e. the two selected vectors are maximally separated along PC1 (i.e. principal component 1); repeating selection of two discrete vectors each for PC2, PC3, . . . , PCn, so as to select two discrete vectors in each iteration, proceeding in the order of PC1, PC2, PC3 . . . . PCn, for generating a first set of reference vectors, wherein the first set of reference vectors comprises of the discrete vector pairs arranged in the order of their selection, i.e. in an order in which the reference vector pairs derived from the extremes of the most significant principal components precede reference vector pairs derived from the extremes of relatively less significant principal components; computing a unidimensional compositional metric for each sequenced biological sequence fragment out of the plurality of sequenced biological sequence fragments as a cumulative function of the distance of the tetra-nucleotide frequency vector (v) corresponding to an individual biological sequence fragment, from the first three or more reference vectors selected out of the generated first set of reference vectors; and segregating each sequenced biological sequence fragment out of the plurality of sequenced biological sequence fragments in to a plurality of groups based on respective unidimensional compositional metric.

### BRIEF DESCRIPTION OF THE DRAWINGS

The foregoing summary, as well as the following detailed description of preferred embodiments, are better understood when read in conjunction with the appended drawings. For the purpose of illustrating the invention, there is shown in the drawings exemplary constructions of the invention; however, the invention is not limited to the specific methods and system disclosed. In the drawings:

FIG. 1: shows a flow chart illustrating a method for representing compositional properties of a biological sequence fragment;

FIG. 2: shows a block diagram illustrating system architecture for representing compositional properties of a biological sequence fragment; and

FIG. 3: shows a flow chart illustrating a method for representing compositional properties of a biological sequence fragment in an embodiment that exemplifies an application of the depicted method in the field of metagenomics.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

Some embodiments of this invention, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

The disclosed embodiments are merely exemplary of the invention, which may be embodied in various forms.

The elements illustrated in the Figures inter-operate as explained in more detail below. Before setting forth the detailed explanation, however, it is noted that all of the discussion below, regardless of the particular implementation being described, is exemplary in nature, rather than limiting. For example, although selected aspects, features, or components of the implementations are depicted as being stored in memories, all or part of the systems and methods consistent with the attrition warning system and method may be stored on, distributed across, or read from other machine-readable media.

The techniques described above may be implemented in one or more computer programs executing on (or executable by) a programmable computer including any appropriate combination of any appropriate number of the following: a processor, a storage medium readable and/or writable by the processor (including, for example, volatile and non-volatile memory and/or storage elements), plurality of input units, and plurality of output devices. Program code may be applied to input entered using any of the plurality of input units to perform the functions described and to generate an output displayed upon any of the plurality of output devices.

Each computer program within the scope of the claims below may be implemented in any programming language, such as assembly language, machine language, a high-level procedural programming language, or an object-oriented programming language. The programming language may, for example, be a compiled or interpreted programming language. Each such computer program may be implemented in a computer program product tangibly embodied in a machine-readable storage device for execution by a computer processor.

Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk.

Any data disclosed herein may be implemented, for example, in one or more data structures tangibly stored on a non-transitory computer-readable medium. Embodiments of the invention may store such data in such data structure(s) and read such data from such data structure(s).

The present application provides a computer implemented method and system for representing compositional properties of a biological sequence fragment using a unidimensional compositional metric.

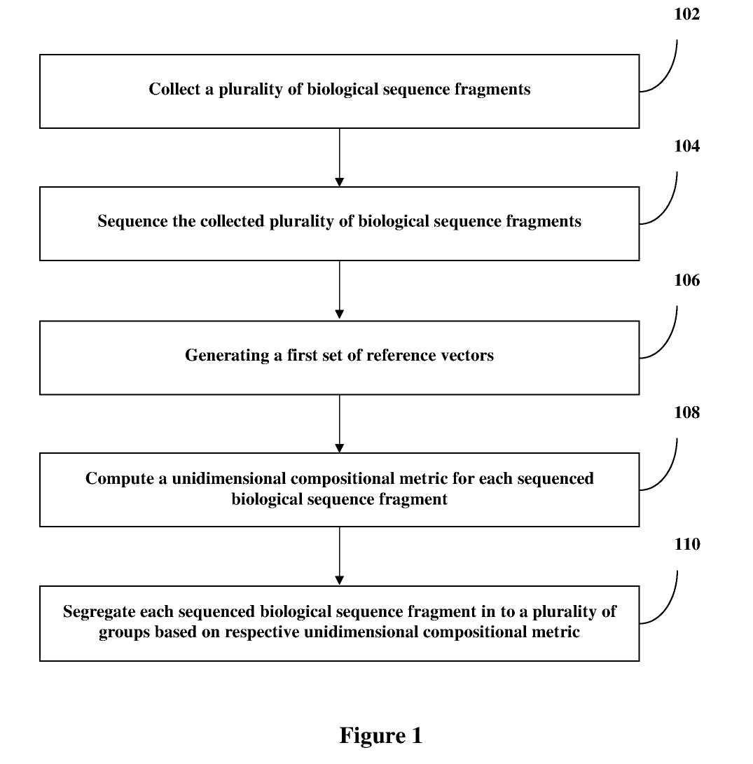

Referring to FIG. 1 is a flow chart illustrating a method for representing compositional properties of a biological sequence fragment.

The process starts at step 102, a plurality of biological sequence fragments are collected. At the step 104, the collected plurality of biological sequence fragments are sequenced. At the step 106, a first set of reference vectors is generated, by generating a 256-dimensional tetra-nucleotide frequency vector (v) corresponding to the each sequenced biological sequence fragment out of the plurality of sequenced biological sequence fragments wherein the 256-dimensional tetra-nucleotide frequency vectors are subjected to Principal Component Analysis (PCA); selecting two vectors that lie at the extremes of the first principal component, i.e. the two selected vectors are maximally separated along PC1 (principal component 1); repeating selection of two discrete vectors each for PC2, PC3, . . . , PCn so as to select two discrete vectors in each iteration, proceeding in the order of PC1, PC2, PC3 . . . . PCn, for generating a first set of reference vectors, wherein the first set of reference vectors comprises of the discrete vector pairs arranged in the order of their selection, i.e. in an order in which the reference vector pairs derived from the extremes of the most significant principal components precede reference vector pairs derived from the extremes of relatively less significant principal components. At the step 108, a unidimensional compositional metric is computed for each sequenced biological sequence fragment out of the plurality of sequenced biological sequence fragments as a cumulative function of the distance of the tetra-nucleotide frequency vector (v) corresponding to an individual biological sequence fragment, from three or more reference vectors selected out of the generated first set of reference vectors. The process ends at the step 110, each sequenced biological sequence fragment out of the plurality of sequenced biological sequence fragments is segregated in to a plurality of groups based on respective unidimensional compositional metric.

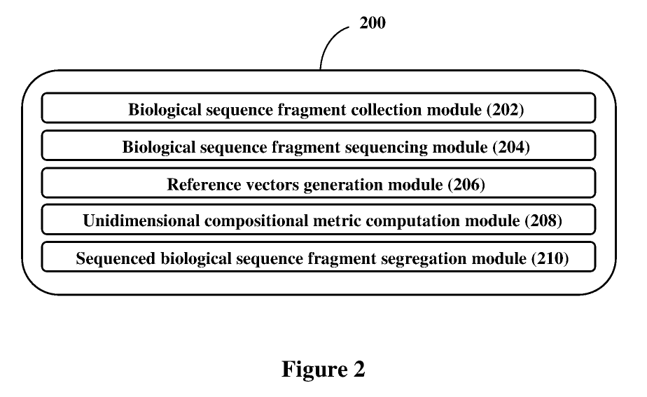

Referring to FIG. 2 is a block diagram illustrating system architecture for representing compositional properties of a biological sequence fragment.

In an embodiment of the present invention, a system (200) is provided for representing compositional properties of a biological sequence fragment using a unidimensional compositional metric.

The system (200) for representing compositional properties of a biological sequence fragment using a unidimensional compositional metric comprising a processor; a data bus coupled to said processor; a computer-usable medium embodying computer code, said computer-usable medium being coupled to said data bus, said computer program code comprising instructions executable by said processor and configured for executing a biological sequence fragment collection module (202); a biological sequence fragment sequencing module (204); a reference vectors generation module (206); a unidimensional compositional metric computation module (208); and a sequenced biological sequence fragment segregation module (210)

In another embodiment of the present invention, the biological sequence fragment collection module (202) is adapted for collecting a plurality of biological sequence fragments. The plurality of biological sequence fragments are collected from a group comprising of genomic and/or metagenomic and/or environmental samples.

In another embodiment of the present invention, the biological sequence fragment sequencing module (204) is adapted for sequencing the collected plurality of biological sequence fragments.

In another embodiment of the present invention, the reference vectors generation module (206) is adapted for generating a 256-dimensional tetra-nucleotide frequency vector (v) corresponding to each sequenced biological sequence fragment out of the plurality of sequenced biological sequence fragments wherein the entire set of 256-dimensional tetra-nucleotide frequency vectors so generated are subjected to Principal Component Analysis (PCA). Further, two vectors that lie at the extremes of the first principal component i.e. maximally separated along PC1 (principal component 1) are first selected. Furthermore, selection of two vectors is repeated for PC2, PC3, . . . , PCn such that two discrete vectors are selected in each iteration, proceeding in the order of PC1, PC2, PC3 . . . . PCn, for generating a first set of reference vectors, wherein the first set of reference vectors comprises of the discrete vector pairs arranged in the order of their selection, i.e. in an order in which the reference vector pairs derived from the extremes of the most significant principal components precede reference vector pairs derived from the extremes of relatively less significant principal components. Given that each of the principal components are orthogonal to each other, the first set of reference vectors (rv1, rv2, rv3, . . . , rvN) generated at the end of this step, are sufficiently separated from each other in the 256 dimensional space.

In an alternative embodiment of the present invention, the reference vectors generation module (206) is adapted for generating n-dimensional frequency vector for a plurality of k-mer frequencies wherein the plurality of k-mer frequencies are other than tetra-nucleotide frequency. The frequency vectors for other k-mer frequencies may also be generated, i.e. other than tetra nucleotide frequencies and therefore the dimensionality of the feature vector space may be other than 256 dimensions.

The distance between the 256-dimensional tetra-nucleotide frequency vector (v) corresponding to the each sequenced biological sequence fragment out of the plurality of sequenced biological sequence fragments is computed using a distance metric. The distance metric used to compute the distance between the 256-dimensional tetra-nucleotide frequency vector (v) corresponding to the each sequenced biological sequence fragment out of the plurality of sequenced biological sequence fragments is selected from a group comprising but not limited to Manhattan distance or Euclidean distance or an appropriate metric suitable for measuring distance in a multidimensional space.

In another embodiment of the present invention, the unidimensional compositional metric computation module (208) is adapted for computing a unidimensional compositional metric for each sequenced biological sequence fragment out of the plurality of sequenced biological sequence fragments as a cumulative function of the distance of the tetra-nucleotide frequency vector (v) corresponding to an individual biological sequence fragment, from the first three or more reference vectors (rv1, rv2, rv3, . . . , rvN) selected out of the generated first set of reference vectors. The unidimensional compositional metric is cmp-score, which is computed according to the following:

cmp-score=dist(v−rv1)+dist(v−rv2)+dist(v−rv3)+ . . . +dist(v−rvN)

In another embodiment of the present invention, the sequenced biological sequence fragment segregation module (210) is adapted for segregating each sequenced biological sequence fragment out of the plurality of sequenced biological sequence fragments in to a plurality of groups based on respective computed unidimensional compositional metric.

The resulting groups, each comprising one or more sequenced biological sequence fragment(s) amongst the plurality of sequenced biological sequence fragments, formed on the basis of respective computed unidimensional compositional metric, are utilized in genomic and/or metagenomic sequence analysis applications which involve/require rapid ordering, comparison, categorization, and annotation of each sequenced biological sequence fragment out of the plurality of sequenced biological sequence fragments.

In an alternative embodiment of the present invention, the computing of the unidimensional compositional metric for each sequenced biological sequence fragment out of the plurality of sequenced biological sequence fragments as a cumulative function of the distance of the tetra-nucleotide frequency vector (v) from three or more reference vectors, wherein the three or more reference vectors are derived from a second set of reference vectors.

The derivation of the second set of reference vectors comprising steps of generating a 256-dimensional tetra-nucleotide frequency vector (v) corresponding to each of a plurality of randomly generated biological sequence fragments of a predetermined length. Wherein, the length of the plurality of randomly generated biological sequence fragments may be determined based on the average length of query sequence(s) for which cmp-score needs to be generated. The plurality of randomly generated biological sequence fragments are derived from completely sequenced genomes. For each of these sequence fragments, vectors representing the frequencies of all possible tetra-nucleotides (in that sequence) are computed. The entire set of 256-dimensional tetra-nucleotide frequency vectors are subjected to Principal Component Analysis (PCA). Further, two vectors that lie at the extremes of the first principal component i.e. maximally separated along PC1 (principal component 1) are first selected. Furthermore, selection of two vectors is repeated for PC2, PC3, . . . , PCn, such that two discrete vectors are selected in each iteration, proceeding in the order of PC1, PC2, PC3 . . . . PCn, for generating a second set of reference vectors, wherein the second set of reference vectors comprises of the discrete vector pairs arranged in the order of their selection, i.e. in an order in which the reference vector pairs derived from the extremes of the most significant principal components precede reference vector pairs derived from the extremes of relatively less significant principal components. Given that each of the principal components are orthogonal to each other, the reference vectors comprising the second set of reference vectors are sufficiently separated from each other in the 256 dimensional space.

The 256-dimensional tetra-nucleotide frequency vector (v) corresponding to the each sequenced biological sequence fragment out of the plurality of sequenced biological sequence fragments generation is a one-time process and may not be repeated before proceeding to subsequent steps of the method and system for representing compositional properties of the biological sequence fragment using the unidimensional compositional metric. Further, the reference vector set generated from one set of biological sequences may be employed for generating cmp-scores for any biological sequence fragment either from the current study or experiment as well as from any other study or experiment.

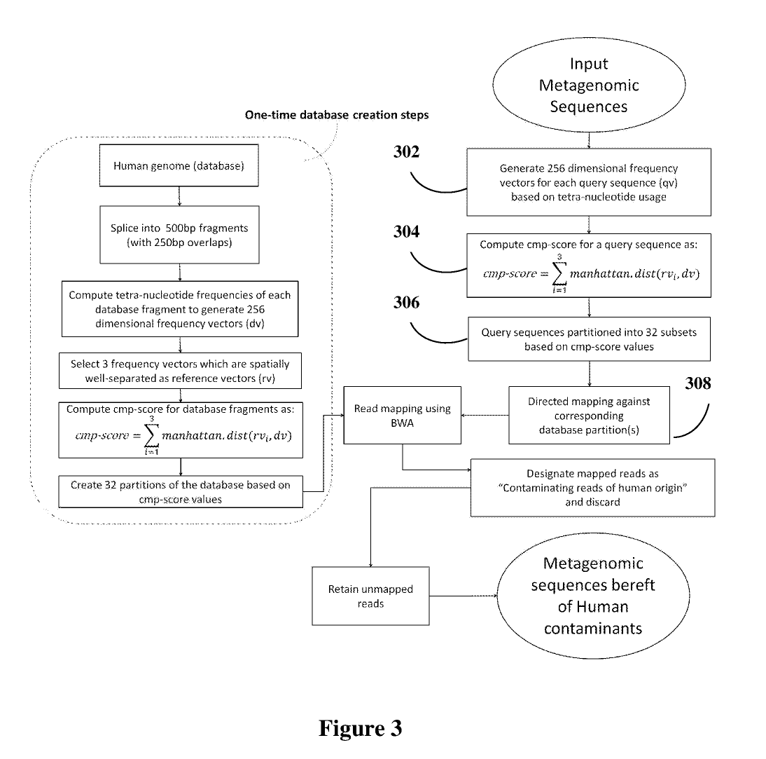

Referring to FIG. 3 is a flow chart illustrating a method for representing compositional properties of a biological sequence fragment in an embodiment that exemplifies an application of the depicted method in the field of metagenomics.

In an exemplary embodiment of the present invention, the unidimensional compositional metric (cmp-score) is utilized for identifying the subset of DNA fragments of human origin which contaminate human-host derived metagenomic datasets.

Utilization of cmp-score for identification and subsequent removal of human-origin reads in metagenomic data sets, is based on the following premise. Sequence similarity between two DNA sequences in most cases translates to approximate similarity in their compositional characteristics. Consequently, instead of searching and mapping all query sequences from a given metagenomic dataset, en masse to the entire human genome, it would be beneficial in terms of both time and memory, if the query sequences can be first either categorized, sorted or ordered according to their compositional features, and subsequently searched or mapped only against the subset of human genome fragments having similar compositional features. Efficiency of the directed-mapping strategy depends on the metric that defines compositional similarity. The cmp-score metric is utilized for this purpose in the current implementation.

At the step 302, the 256 dimensional tetra-nucleotide frequency vectors are generated for all ‘query’ sequences constituting the metagenomic dataset. Computing the cmp-score for any given DNA fragment, involves comparing the tetra-nucleotide frequency vector corresponding to the fragment with three or more reference points or reference vectors in the 256 dimensional feature vector space. For the purpose of the present implementation, ‘three reference vectors’ were chosen using the following procedure. In the current implementation, DNA sequence fragments of length 500 base pairs (bp), each were randomly generated from the entire human genome. For each of these sequence fragments, vectors representing the frequencies of all possible tetra-nucleotides in that sequence were computed. Guided by principal component analysis (PCA), and following the steps for generating a set of reference vectors as described earlier, three spatially well separated vectors were then chosen as the reference vectors henceforth referred to as rv1, rv2 and rv3.

In the present implementation, the spatially well separated vectors were generated by taking DNA fragments from the database i.e. human genome. In other implementation based on the end objectives or requirements, these spatially well separated vectors may be generated from DNA sequence fragments constituting the query dataset itself and/or obtained using mathematical procedures and/or DNA sequence fragments of a predetermined length are randomly generated from completely sequenced/draft sequenced genomes from any other data source. It should be noted that the length of the randomly generated DNA sequence fragments may be determined based on the average length of query sequence(s) for which cmp-score needs to be generated.

At the step 304, cmp-scores are computed. In the present implementation, the cmp-score for any given DNA sequence was subsequently calculated as the cumulative Manhattan distance between its tetra-nucleotide frequency vector (v) and each of the ‘three’ reference vectors (rv1, rv2 and rv3) generated in step 1 described above.

cmp-score=dist(v,rv1)+dist(v,rv2)+dist(v,rv3)

In the present implementation, the cmp-score was generated based on Manhattan distance. In other implementations, other distance measures such as Euclidean or Chebyshev etc. may be employed. In the present implementation, the cmp-score was computed based on 3 reference vectors. In other implementations, more than 3 reference vectors may be employed.

Following a set of one time database creation steps, the human genome database is partitioned into smaller subsets based on cmp-scores. The human genome was partitioned into compositionally similar subsets, each set containing fragments having cmp-score values in a pre-defined range. In order to create these subsets, the human chromosomal sequences were first segmented into 500 bp fragments with an overlap of 250 bp. The cmp-score values were computed for each of these fragments as described in step 304. The majority of the cmp-score values were observed to range between 900-1525. In the present implementation, based on the cmp-score values, the human DNA fragments were partitioned into 32 subsets. These subsets correspond to the following pre-defined cmp-score ranges—

<910, 911-930, 931-950, 951-970, 971-990, 991-1010, 1011-1030, 1031-1050, 1051-1070, 1071-1090, 1091-1110, 1111-1130, 1131-1150, 1151-1170, 1171-1190, 1191-1210, 1211-1230, 1231-1250, 1251-1270, 1271-1290, 1291-1310, 1311-1330, 1331-1350, 1351-1370, 1371-1390, 1391-1410, 1411-1430, 1431-1450, 1451-1470, 1471-1490, 1491-1510, >1510

Sequence fragments in each subset were appropriately formatted and subsequently indexed using the BWA algorithm. This partitioned human genome database is used by the cmp-score workflow for the directed read mapping step 308.

At the step 306, the query sequences constituting the metagenomic dataset is partitioned into 32 subsets, based on cmp-score, to be used for the directed read-mapping. For the directed read-mapping step, cmp-score values for each of the query sequences, brought forward from the first step, are computed as mentioned in step 304. Based on the cmp-score values, the query sequences are sorted and partitioned into 32 sub-groups, having cmp-score ranges identical to those of the (human) database partitions.

At step 308, sequences in each of the 32 query sequence sub-groups are then mapped, using the fastmap application of BWA, to appropriate subsets of the pre-partitioned human genome database. For directed mapping of sequences belonging to each query sub-group, specific subsets of the partitioned human genome database are considered. These subsets are chosen such that their cmp-score values lie in the range of +/−60 with respect to those of the query sub-group. The range of ‘+/−60’ was determined empirically by calculating cmp-score values of a large number of randomly generated human genome fragments, and comparing these cmp-score values against those of their closest counterparts (similar sequences) in the pre-partitioned human genome database.

The fastmap application of BWA is designed for mapping or aligning sequences without any gaps or substitutions. The results obtained from the fastmap tool are parsed by the cmp-score algorithm and ‘stitched’ together into longer alignments. This allows accommodation for natural variations in the human genome as well as sequencing errors. Query sequences from a metagenomic dataset, which align to the fragments in the pre-partitioned human genome database with >=96% identity, are categorized as human genome contaminants. These contaminant sequences are removed from the query metagenomic dataset to obtain an output file which is bereft of contaminating human genome sequences.

Further, cmp-score based human contamination removal procedure is validated with simulated metagenomic datasets. A total of 18 simulated metagenomic datasets were used for validating the performance of cmp-score based contamination removal procedure. While 80% of reads in each dataset originated from prokaryotic genomes, randomly pooled from completely sequenced prokaryotic genomes available in the NCBI database, the remaining 20% were sourced from the human genome. Based on the length of constituent reads, the 18 datasets were divided into three equal groups, of average read-lengths around 250 bp, 400 bp, and 600 bp. These read-lengths are representative of present day sequencing technologies such as Illumina-MiSeq, Roche-454 which are routinely employed in metagenomic sequencing studies. While the sequence length of paired-end reads (150 bp×2) from Illumina is in the minimum range of 250-300 bp, when merged, different Roche-454 sequencing platforms yield sequences having average lengths of 250, 400 and 600 bp. Based on the number of reads, 1 million, 2.5 million and 5 million in each dataset, each group was further subdivided into 3 subgroups, having 2 datasets each. Given that the present generation of sequencing technologies are reported to have a sequencing error rate of around 1%, in-house scripts were employed for introducing 1% random mutations including insertions, deletions, substitutions in one of the datasets in each subgroup. For the purpose of comparison, all datasets were individually analyzed using cmp-score-based contamination removal procedure as well as a state-of-the-art program meant for the same purpose i.e. DeconSeq. The parameters of DeconSeq were suitably modified to enable it to identify human sequences (with an allowed error rate of 1%). Results were analysed with respect to (a) total execution time, (b) peak memory usage, and (c) sensitivity and specificity of detecting contaminating human sequences. For each individual dataset, the peak memory requirements for both cmp-score-based contamination removal procedure and DeconSeq were also captured. All validation experiments were performed on a system with an Intel Xeon processor (2.33 GHz) with 64 GB RAM.

Following tables summarizes the results:

TABLE 1
This table indicates the ability of cmp-score-based contamination removal procedure
in terms of sensitivity and specificity of detecting contaminating human sequences

| | | | | | Total | Sensitivity | Specificity |
|---|---|---|---|---|---|---|---|
| | Length of | Percentage | No of sequences | | Number of | of detecting | of detecting |
| | sequences | of | in dataset | | sequences | human | human |
| Dataset | (bp) | mutations | Prokaryotic | Human | in dataset | sequences | sequences |
| PH_250_1M_0mut.ffn | 250 | 0 | 800000 | 200000 | 1000000 | 0.99 | 0.97 |
| PH_250_1M_1mut.ffn | 250 | 1 | 800000 | 200000 | 1000000 | 0.98 | 0.97 |
| PH_250_2.5M_0mut.ffn | 250 | 0 | 2000000 | 500000 | 2500000 | 0.99 | 0.97 |
| PH_250_2.5M_1mut.ffn | 250 | 1 | 2000000 | 500000 | 2500000 | 0.99 | 0.97 |
| PH_250_5M_0mut.ffn | 250 | 0 | 4000000 | 1000000 | 5000000 | 0.99 | 0.97 |
| PH_250_5M_1mut.ffn | 250 | 1 | 4000000 | 1000000 | 5000000 | 0.99 | 0.97 |
| PH_400_1M_0mut.ffn | 400 | 0 | 800000 | 200000 | 1000000 | 0.99 | 0.99 |
| PH_400_1M_1mut.ffn | 400 | 1 | 800000 | 200000 | 1000000 | 0.98 | 0.99 |
| PH_400_2.5M_0mut.ffn | 400 | 0 | 2000000 | 500000 | 2500000 | 0.99 | 0.99 |
| PH_400_2.5M_1mut.ffn | 400 | 1 | 2000000 | 500000 | 2500000 | 0.98 | 0.99 |
| PH_400_5M_0mut.ffn | 400 | 0 | 4000000 | 1000000 | 5000000 | 0.99 | 0.99 |
| PH_400_5M_1mut.ffn | 400 | 1 | 4000000 | 1000000 | 5000000 | 0.98 | 0.99 |
| PH_600_1M_0mut.ffn | 600 | 0 | 800000 | 200000 | 1000000 | 0.99 | 0.99 |
| PH_600_1M_1mut.ffn | 600 | 1 | 800000 | 200000 | 1000000 | 0.99 | 0.99 |
| PH_600_2.5M_0mut.ffn | 600 | 0 | 2000000 | 500000 | 2500000 | 0.99 | 0.99 |
| PH_600_2.5M_1mut.ffn | 600 | 1 | 2000000 | 500000 | 2500000 | 0.99 | 0.99 |
| PH_600_5M_0mut.ffn | 600 | 0 | 4000000 | 1000000 | 5000000 | 0.99 | 0.99 |
| PH_600_5M_1mut.ffn | 600 | 1 | 4000000 | 1000000 | 5000000 | 0.99 | 0.99 |

TABLE 2
This table provides a comparison of total execution time and peak
memory usage statistics for detecting contaminating sequences
using an implementation employing cmp-scores, and DeConseq

| | Peak memory | | | |
|---|---|---|---|---|
| | usage for detecting | | Time taken for detecting | |
| | contaminating sequences | | contaminating sequences | |
| | (in Gigabytes) | | (in Minutes) | |
| | Current | | Current | |
| | method | | method | |
| | utilizing | Using | utilizing | Using |
| | cmp- | DeConseq | cmp- | DeConseq |
| Input Dataset | scores | (state of art) | scores | (state of art) |
| 1M (250 bp) | 1.8 | 4.5 | 33 | 39 |
| 1M (400 bp) | 1.9 | 5.2 | 39 | 65 |
| 1M (600 bp) | 2.1 | 6.2 | 36 | 106 |
| 2.5M (250 bp) | 1.9 | 6.3 | 80 | 96 |
| 2.5M (400 bp) | 2.1 | 8.1 | 89 | 163 |
| 2.5M (600 bp) | 2.2 | 10.5 | 93 | 255 |
| 5M (250 bp) | 2 | 9.3 | 179 | 193 |
| 5M (400 bp) | 2.1 | 12.9 | 176 | 326 |
| 5M (600 bp) | 2.3 | 17.6 | 185 | 517 |

The present invention provides the method and system for representing compositional properties of a biological sequence fragment using the unidimensional compositional metric. Further, the method and system may be appropriately modified and extended to non-nucleotide biological sequences such as amino-acid sequences.

The present invention represents biological sequences using a unidimensional compositional metric. The unidimensional compositional metric used in the present invention is able to sufficiently capture the compositional features of any query sequence. The present invention therefore proposes an efficient way of scaling multidimensional biological sequence composition vectors to a unidimensional metric. The unidimensional compositional metric has applicability in downstream bioinformatics applications which involve large-scale comparison of biological sequences. The unidimensional compositional metric, being unidimensional, enables rapid comparison and segregation of biological sequences, and computations using this metric are significantly less compute intensive.

We claim:

1. A method for representing compositional properties of a biological sequence fragment using a unidimensional compositional metric, characterized in generating a set of spatially well separated reference vectors in a feature vector space pertaining to said compositional properties of said biological sequence fragment, for generating said unidimensional metric; said method comprising processor implemented steps of:
a. collecting a plurality of biological sequence fragments using a biological sequence fragment collection module (202);
b. sequencing collected plurality of biological sequence fragments using a biological sequence fragment sequencing module (204);
c. generating a 256-dimensional tetra-nucleotide frequency vector (v) corresponding to the each sequenced biological sequence fragment out of the plurality of sequenced biological sequence fragments; subjecting the 256-dimensional tetra-nucleotide frequency vectors to Principal Component Analysis (PCA); selecting two vectors that lie at the extremes of the first principal component (PC1) and are therefore maximally separated along PC1; repeating the selection of two discrete vectors for each of PC2, PC3, . . . , PCn, so as to select two discrete vectors in each iteration for generating a first set of reference vectors using a reference vectors generation module (206) wherein the first set of reference vectors comprises of the discrete vector pairs arranged in the order of their selection, in an order in which the reference vector pairs derived from the extremes of the most significant principal components precede reference vector pairs derived from the extremes of relatively less significant principal components;
d. computing a unidimensional compositional metric for each sequenced biological sequence fragment out of the plurality of sequenced biological sequence fragments as a cumulative function of the distance of the tetra-nucleotide frequency vector (v) corresponding to an individual biological sequence fragment from the first three or more reference vectors selected out of the generated first set of reference vectors using a unidimensional compositional metric computation module (208); and
e. segregating each sequenced biological sequence fragment out of the plurality of sequenced biological sequence fragments in to a plurality of groups based on respective value of the unidimensional compositional metric using a sequenced biological sequence fragment segregation module (210).

2. The method as claimed in claim 1, wherein the plurality of biological sequence fragments are collected from a group comprising of genomic, metagenomic, and environmental samples.

3. The method as claimed in claim 1, wherein the unidimensional compositional metric is cmp-score.

4. The method as claimed in claim 1, wherein the distance between the 256-dimensional tetra-nucleotide frequency vector (v) corresponding to the each sequenced biological sequence fragment out of the plurality of sequenced biological sequence fragments is computed using a distance metric selected from a group comprising Manhattan distance, Euclidean distance, and an appropriate metric suitable for measuring distance in a multidimensional space.

5. The method as claimed in claim 1, further comprises of generating n-dimensional frequency vector for a plurality of k-mer frequencies wherein the plurality of k-mer frequencies are other than tetra-nucleotide frequency.

6. The method as claimed in claim 1, wherein the reference vectors constitutes randomly generated 256 dimensional vectors that are discrete in feature vector space.

7. The method as claimed in claim 1, further comprises of utilizing resulting groups in efficient and rapid ordering, comparison, categorization, and thereby aiding in annotation of sequenced biological sequence fragments.

8. The method as claimed in claim 1, further comprises of computing the unidimensional compositional metric for each sequenced biological sequence fragment out of the plurality of sequenced biological sequence fragments as a cumulative function of the distance of the tetra-nucleotide frequency vector (v) corresponding to an individual biological sequence fragment from the first three or more reference vectors, wherein the three or more reference vectors are derived from a second set of reference vectors.

9. The method as claimed in claim 8, wherein derivation of the second set of reference vectors comprising steps of generating a 256-dimensional tetra-nucleotide frequency vector (v) corresponding to a plurality of randomly generated biological sequence fragments of a predetermined length, subjecting the 256-dimensional tetra-nucleotide frequency vectors to Principal Component Analysis (PCA); selecting two vectors that lie at the extremes of the first principal component (PC1) and are therefore maximally separated along PC1; repeating the selection of two discrete vectors for each of PC2, PC3, . . . , PCn, so as to select two discrete vectors in each iteration for generating the second set of reference vectors wherein the second set of reference vectors comprises of the discrete vector pairs arranged in the order of their selection, in an order in which the reference vector pairs derived from the extremes of the most significant principal components precede reference vector pairs derived from the extremes of relatively less significant principal components.

10. The method as claimed in claim 8, wherein the plurality of randomly generated biological sequence fragments are derived from completely sequenced genomes.

11. The method as claimed in claim 1, wherein generating the 256-dimensional tetra-nucleotide frequency vector (v) corresponding to the each sequenced biological sequence fragment out of the plurality of sequenced biological sequence fragments; subjecting the 256-dimensional tetra-nucleotide frequency vectors to Principal Component Analysis (PCA); selecting two vectors that lie at the extremes of the first principal component (PC1) and are therefore maximally separated along PC1; repeating the selection of two discrete vectors for each of PC2, PC3, . . . , PCn, so as to select two discrete vectors in each iteration for generating the first set of reference vectors using the reference vectors generation module (206) wherein the first set of reference vectors comprises of the discrete vector pairs arranged in the order of their selection, in the order in which the reference vector pairs derived from the extremes of the most significant principal components precede reference vector pairs derived from the extremes of relatively less significant principal components, is a one-time process.

12. A system (200) for representing compositional properties of a biological sequence fragment using a unidimensional compositional metric, characterized in generating a set of spatially well separated reference vectors in a feature vector space pertaining to said compositional properties of said biological sequence fragment, for generating said unidimensional metric; said system (200) comprising:
a. a processor;
b. a data bus coupled to said processor;
c. a computer-usable medium embodying computer code, said computer-usable medium being coupled to said data bus, said computer program code comprising instructions executable by said processor and configured for executing:
a biological sequence fragment collection module (202) adapted for collecting a plurality of biological sequence fragments;
a biological sequence fragment sequencing module (204) adapted for sequencing collected plurality of biological sequence fragments;
a reference vectors generation module (206) adapted for generating a 256-dimensional tetra-nucleotide frequency vector (v) corresponding to the each sequenced biological sequence fragment out of the plurality of sequenced biological sequence fragments; subjecting the 256-dimensional tetra-nucleotide frequency vectors to Principal Component Analysis (PCA); selecting two vectors that lie at the extremes of the first principal component (PC1) and are therefore maximally separated along PC1; repeating the selection of two discrete vectors for each of PC2, PC3, . . . , PCn, so as to select two discrete vectors in each iteration for generating a first set of reference vectors, wherein the first set of reference vectors comprises of the discrete vector pairs arranged in the order of their selection, in an order in which the reference vector pairs derived from the extremes of the most significant principal components precede reference vector pairs derived from the extremes of relatively less significant principal components;
a unidimensional compositional metric computation module (208) adapted for computing a unidimensional compositional metric for each sequenced biological sequence fragment out of the plurality of sequenced biological sequence fragments as a cumulative function of the distance of the tetra-nucleotide frequency vector (v) corresponding to an individual biological sequence fragment from the first three or more reference vectors selected out of the generated first set of reference vectors; and
a sequenced biological sequence fragment segregation module (210) adapted for segregating each sequenced biological sequence fragment out of the plurality of sequenced biological sequence fragments in to a plurality of groups based on respective value of the unidimensional compositional metric.

13. A non-transitory computer-readable medium having embodied thereon a computer program for representing compositional properties of a biological sequence fragment using a unidimensional compositional metric, characterized in generating a set of spatially well separated reference vectors in a feature vector space pertaining to said compositional properties of said biological sequence fragment, for generating said unidimensional metric; said method comprising steps of:
a. collecting a plurality of biological sequence fragments using a biological sequence fragment collection module (202);
b. sequencing collected plurality of biological sequence fragments using a biological sequence fragment sequencing module (204);
c. generating a 256-dimensional tetra-nucleotide frequency vector (v) corresponding to the each sequenced biological sequence fragment out of the plurality of sequenced biological sequence fragments; subjecting the 256-dimensional tetra-nucleotide frequency vectors to Principal Component Analysis (PCA); selecting two vectors that lie at the extremes of the first principal component (PC1) and are therefore maximally separated along PC1; repeating the selection of two discrete vectors for each of PC2, PC3, . . . , PCn, so as to select two discrete vectors in each iteration for generating a first set of reference vectors using a reference vectors generation module (206) wherein the first set of reference vectors comprises of the discrete vector pairs arranged in the order of their selection, in an order in which the reference vector pairs derived from the extremes of the most significant principal components precede reference vector pairs derived from the extremes of relatively less significant principal components;
d. computing a unidimensional compositional metric for each sequenced biological sequence fragment out of the plurality of sequenced biological sequence fragments as a cumulative function of the distance of the tetra-nucleotide frequency vector (v) corresponding to an individual biological sequence fragment from the first three or more reference vectors selected out of the generated first set of reference vectors using a unidimensional compositional metric computation module (208); and
e. segregating each sequenced biological sequence fragment out of the plurality of sequenced biological sequence fragments in to a plurality of groups based on respective value of the unidimensional compositional metric using a sequenced biological sequence fragment segregation module (210).
